(19) United States
(12) Patent Application Publication
(10) Pub. No.: US 2017/0091112 A1
(43) Pub. Date: Mar. 30, 2017

(54) CONFIGURABLE CACHE ARCHITECTURE

(71) Applicant: International Business Machines Corporation, Armonk, NY (US)

(72) Inventor: Philip G. Emma, Danbury, CT (US)

(21) Appl. No.: 14/949,946

(22) Filed: Nov. 24, 2015

Related U.S. Application Data
(63) Continuation of application No. 14/870,436, filed on Sep. 30, 2015.

(51) Int. Cl. G06F 12/08

(52) U.S. Cl. CPC G06F 12/0897; G06F 2212/6012

(57) ABSTRACT

Embodiments relate to providing a configurable cache memory. An aspect includes configuring, via a cache configuration logic, a plurality of cache memories that make up the configurable cache memory into a selected mode, wherein the plurality of cache memories comprise physically separate memory modules, and wherein the plurality of cache memories are linked by the cache configuration logic. Another aspect includes operating the configurable cache memory in the selected mode, wherein the configurable cache memory is capable of operating in a plurality of modes.

### DOMESTIC PRIORITY

This application is a continuation of U.S. patent application Ser. No. 14/870,436, filed Sep. 30, 2015, and all the benefits accruing therefrom under 35 U.S.C. §119, the contents of which is herein incorporated by reference in its entirety.

### BACKGROUND

The present invention relates generally to cache memory for a computer system, and more specifically, to a configurable cache architecture.

Data processing systems typically include a central processing unit (CPU) that executes instructions of a program stored in a main memory. To improve the memory response time, cache memories are used as high-speed buffers emulating the main memory. In general, a cache includes a directory to track stored memory addresses and a data array for storing data items present in the memory addresses. If a data item requested by the CPU is present in the cache, the requested data item is called a cache hit. If a data item requested by the CPU is not present in the cache the requested data item is called a cache miss.

The cache is usually smaller than the main memory, thereby limiting the amount of data that may be stored in the cache. To exploit temporal and spatial locality of data references, caches often store a most recently referenced data item, and store contiguous (in address) blocks of data items, respectively. The contiguous block of data items is referred as a cache line, and is the unit of transfer from the main memory to the cache. The choice of the number of bytes in a cache line is one parameter in a cache design. In a fixed size cache, a small line size, exploits temporal locality, and allows more unique lines to be stored, but increases the size of the directory. A large line size exploits spatial locality, but increases the amount of time needed to transfer the line from main memory to cache (a cache miss penalty), and limits the number of unique lines that can be resident in the cache at the same time.

### SUMMARY

Embodiments include a method for providing a configurable cache memory. An aspect includes configuring, via a cache configuration logic, a plurality of cache memories that make up the configurable cache memory into a selected mode, wherein the plurality of cache memories comprise physically separate memory modules, and wherein the plurality of cache memories are linked by the cache configuration logic. Another aspect includes operating the configurable cache memory in the selected mode, wherein the configurable cache memory is capable of operating in a plurality of modes.

### BRIEF DESCRIPTION OF THE DRAWINGS

The subject matter which is regarded as embodiments is particularly pointed out and distinctly claimed in the claims at the conclusion of the specification. The forgoing and other features, and advantages of the embodiments are apparent from the following detailed description taken in conjunction with the accompanying drawings in which:

FIG. 1 depicts a configurable cache memory in accordance with an embodiment;

FIG. 2 depicts a configurable cache memory that is configured as two separate, coherent caches in accordance with an embodiment;

FIG. 3 depicts a configurable cache memory that is configured as a single cache in an extended mode in accordance with an embodiment;

FIG. 4 depicts a configurable cache memory that is configured as a hierarchical cache comprising a main cache and a victim cache in accordance with an embodiment;

FIG. 5 depicts a configurable cache memory that is configured as a single cache in a double-line mode in accordance with an embodiment;

FIG. 6 depicts a process flow for providing a configurable cache memory in accordance with an embodiment; and

FIG. 7 depicts an embodiment of a computer system that may be used in conjunction with embodiments of a configurable cache memory.

### DETAILED DESCRIPTION

Embodiments of a configurable cache memory are provided, with exemplary embodiments being discussed below in detail. The configurable cache memory comprises one or more physically separate cache memories that may be operated either as a single cache memory or as separate caches, in various modes, depending on the application for which the cache is used. In various embodiments, the configurable cache memory is dynamically configurable into any of the following modes: independent, separate caches; a system of coherent, separate caches; a system of hierarchical caches, or a single, integral cache, which may have a configurable line size in some embodiments. For example, a configurable cache memory that is run as a single cache may have a doubled line size, or may have a doubled overall size with a single line size. The configuration of the configurable cache memory is selected based on the application for which the cache will be used in a computer system. The configurable cache memory includes a cache configuration logic that allows the plurality of caches that make up the configurable cache memory to operate in the various modes.

A configurable cache memory may comprise separate physical cache memories that are built using different technologies, having different sizes, access times, and/or bandwidths. For example, static random access memory (SRAM) memory and dynamic random access memory (DRAM) may be combined in a single configurable cache memory. When conjoining physical memories that are built in differing technologies into a single configurable cache memory, performance characteristics between the physical memories may vary depending on where data that is requested by a fetch request to the cache memory physically resides in the cache.

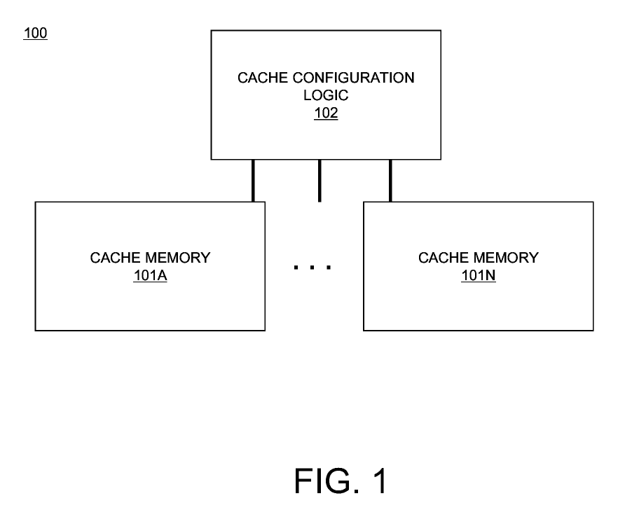

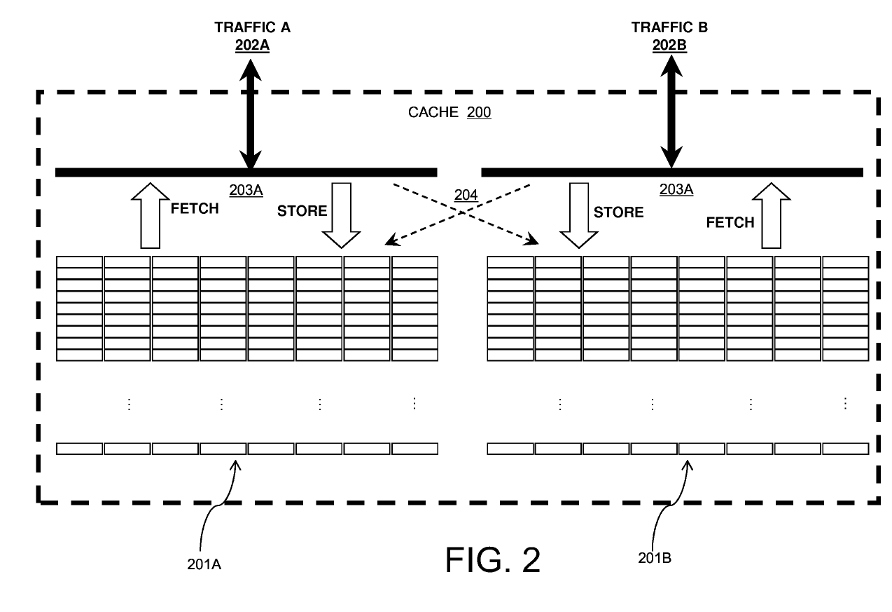

FIG. 1 illustrates an embodiment of a configurable cache memory 100. The configurable cache memory 100 includes separate physical cache memories 101A-N, or memory modules, linked by a cache configuration logic 102. The cache configuration logic 102 configures the configurable cache memory 100 into various modes, examples of which are discussed below with respect to FIGS. 2-5. Embodiments of a single configurable cache memory 100 may be configured into any of the modes discussed below with respect to FIGS. 2-5, depending on the application for which the configurable cache memory will be used. During operation of configurable cache memory 100, the cache memories 101A-N may communicate via the cache configuration logic 102. A configurable cache memory 100 may include any appropriate number of cache memories 101A-N, and each of the cache memories 101A-N may be of any appropriate type, e.g., SRAM or DRAM, and may be of varying sizes in various embodiments. Further, caches 101A-N may be on different chips in some embodiments. A configurable cache memory 100 may comprise any appropriate level of cache in a computer system. Further, cache configuration logic 102 may comprise any appropriate components in various embodiments, such as multiplexers and/or switches.

FIG. 2 depicts a configurable cache memory 200 that is configured as two separate, coherent caches 201A-B in accordance with an embodiment. Caches 201A-B comprise an embodiment of cache memories 101A-N of FIG. 1, and are connected by a cache configuration logic 102. Cache 201A is used exclusively for traffic 202A from a first thread A, and Cache 201B is used exclusively for traffic 202B from a second thread B. Traffic 202A from thread A is received on cache fetch/store interface 203A of cache 201A. Traffic 202B from thread B is received on cache fetch/store interface 203B of cache 201B. The separate caches 201A-B are kept coherent with one another via coherency notification interface 204, which notifies each cache regarding fetches and stores that were performed in the other cache.

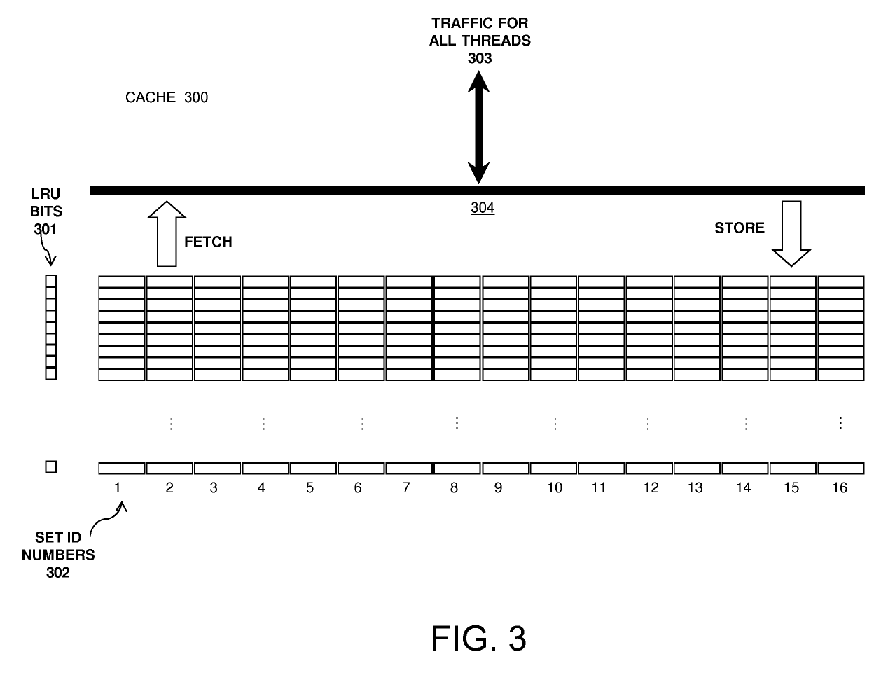

FIG. 3 depicts a configurable cache memory 300 that is configured as a single cache in an extended mode accordance with an embodiment. Cache 300 comprises an embodiment of cache memories 101A-N of FIG. 1 in which the cache memories 101A-N are joined together and operated as a single cache, and are connected by a cache configuration logic 102. Cache 300 is a single, extended cache with double the number of sets as compared to the separate caches 201A-B of FIG. 2. Traffic 300 for all threads is handled by the cache 300. Traffic 303 is received on fetch/store interface 304. Least recently used (LRU) bits 301 are used to determine evictions from the cache 300. Data is organized in the cache 300 based on set identifier (ID) numbers 302.

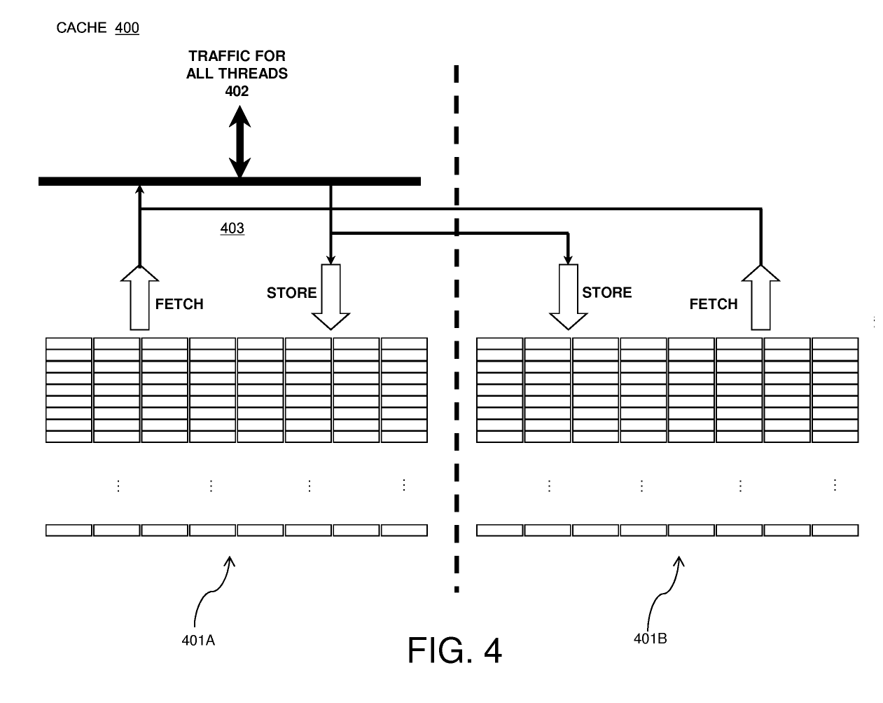

FIG. 4 depicts a configurable cache memory 400 that is configured as a hierarchical cache comprising a main cache 401A and a victim cache 401B in accordance with an embodiment. Caches 401A-B comprise an embodiment of cache memories 101A-N of FIG. 1, and are connected by a cache configuration logic 102. Traffic 402 for all threads is received on a single fetch/store interface 403, and fetches and stores may be processed using both main cache 401A and victim cache 401B. In the event of a cache miss in main cache 401A, victim cache 401B is checked for the desired data. In some embodiments, main cache 401A may comprise a relatively fast type of memory, such as SRAM, while victim cache 401B may comprise a slower type of memory, such as DRAM, and may reside on a separate chip.

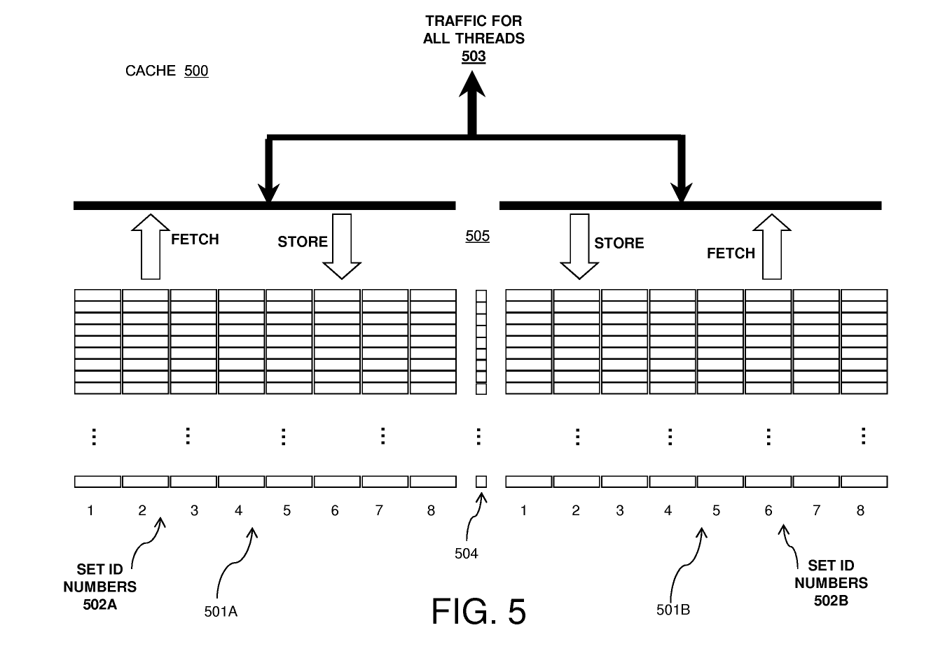

FIG. 5 depicts a configurable cache memory 500 that is configured as a single cache in a double-line size mode in accordance with an embodiment. Caches 501A-B comprise an embodiment of cache memories 101A-N of FIG. 1, and are connected by a cache configuration logic 102. The cache memory 500 is operated as a single cache in a double-line mode, with one half of the cache being designated as even and the other half of the cache being designated as odd. The directory 504 indicates which half of each line is on which side 501A or 501B. Each side has a respective set of set ID numbers 502A-B. Traffic 503 for all threads is received in fetch/store interface 505.

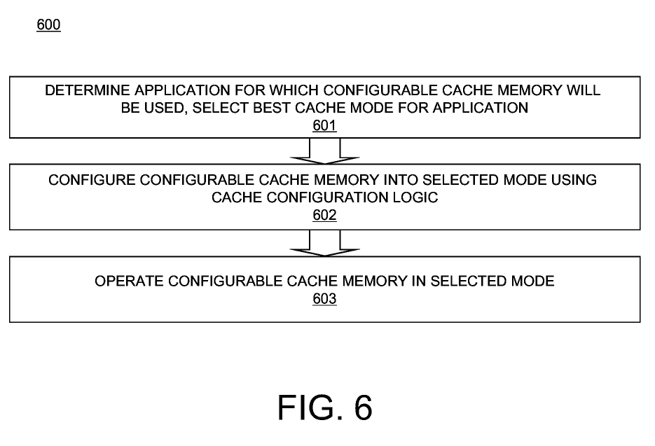

FIG. 6 depicts a method 600 for providing a configurable cache memory in accordance with an embodiment. First in block 601, it is determined what application a configurable cache memory will be used for in a computing system. Then, in block 602, the configurable cache memory, such as configurable cache memory 100 of FIG. 1, is configured, using a cache configuration logic 102, into a mode that is selected as appropriate for the determined application. The mode may correspond to any of the modes discussed above with respect to FIGS. 2-5, i.e., separate caches, a single cache in extended or double-line mode, or a hierarchical cache. Then, in block 603, the configurable cache memory is operated in the selected mode.

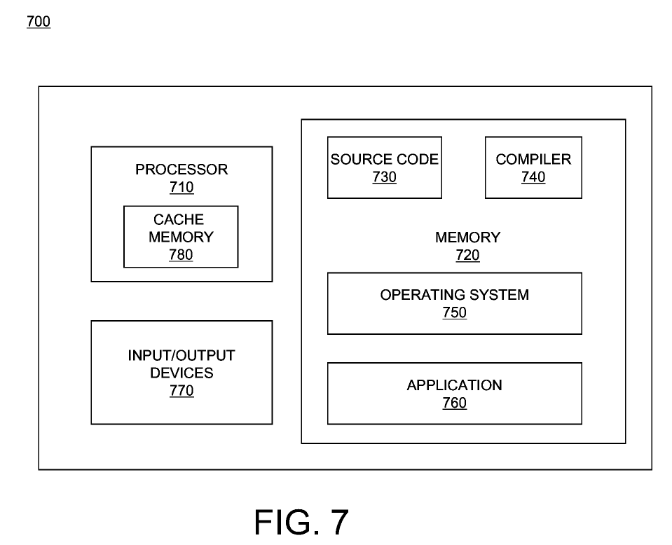

FIG. 7 illustrates an example of a computer 700 which may be utilized by exemplary embodiments of a configurable cache memory. Various operations discussed above may utilize the capabilities of the computer 700. One or more of the capabilities of the computer 700 may be incorporated in any element, module, application, and/or component discussed herein. For example, embodiments of a configurable cache memory may comprise cache memory 780 in processor 710.

The computer 700 includes, but is not limited to, PCs, workstations, laptops, PDAs, palm devices, servers, storages, and the like. Generally, in terms of hardware architecture, the computer 700 may include one or more processors 710, memory 720, and one or more I/O devices 770 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 710 is a hardware device for executing software that can be stored in the memory 720. The processor 710 can be virtually any custom made or commercially available processor, a central processing unit (CPU), a digital signal processor (DSP), or an auxiliary processor among several processors associated with the computer 700, and the processor 710 may be a semiconductor based microprocessor (in the form of a microchip) or a macroprocessor. The processor 710 further comprises a cache memory 780, which may comprise any of the embodiments of a configurable cache memory discussed above.

The memory 720 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 720 may incorporate electronic, magnetic, optical, and/or other types of storage media. Note that the memory 720 can have a distributed architecture, where various components are situated remote from one another, but can be accessed by the processor 710.

The software in the memory 720 may include one or more separate programs, each of which comprises an ordered listing of executable instructions for implementing logical functions. The software in the memory 720 includes a suitable operating system (O/S) 750, compiler 740, source code 730, and one or more applications 760 in accordance with exemplary embodiments. As illustrated, the application 760 comprises numerous functional components for implementing the features and operations of the exemplary embodiments. The application 760 of the computer 700 may represent various applications, computational units, logic, functional units, processes, operations, virtual entities, and/or modules in accordance with exemplary embodiments, but the application 760 is not meant to be a limitation.

The operating system 750 controls the execution of other computer programs, and provides scheduling, input-output control, file and data management, memory management, and communication control and related services. It is contemplated by the inventors that the application 760 for implementing exemplary embodiments may be applicable on all commercially available operating systems.

Application 760 may be a source program, executable program (object code), script, or any other entity comprising a set of instructions to be performed. When a source program, then the program is usually translated via a compiler (such as the compiler 740), assembler, interpreter, or the like, which may or may not be included within the memory 720, so as to operate properly in connection with the O/S 750. Furthermore, the application 760 can be written as an object oriented programming language, which has classes of data and methods, or a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices 770 may include input devices such as, for example but not limited to, a mouse, keyboard, scanner, microphone, camera, etc. Furthermore, the I/O devices 770 may also include output devices, for example but not limited to a printer, display, etc. Finally, the I/O devices 770 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 770 also include components for communicating over various networks, such as the Internet or intranet.

If the computer 700 is a PC, workstation, intelligent device or the like, the software in the memory 720 may further include a basic input output system (BIOS) (omitted for simplicity). The BIOS is a set of essential software routines that initialize and test hardware at startup, start the O/S 750, and support the transfer of data among the hardware devices. The BIOS is stored in some type of read-only-memory, such as ROM, PROM, EPROM, EEPROM or the like, so that the BIOS can be executed when the computer 700 is activated.

When the computer 700 is in operation, the processor 710 is configured to execute software stored within the memory 720, to communicate data to and from the memory 720, and to generally control operations of the computer 700 pursuant to the software. The application 760 and the O/S 750 are read, in whole or in part, by the processor 710, perhaps buffered within the processor 710, and then executed.

When the application 760 is implemented in software it should be noted that the application 760 can be stored on virtually any computer readable storage medium for use by or in connection with any computer related system or method. In the context of this document, a computer readable storage medium may be an electronic, magnetic, optical, or other physical device or means that can contain or store a computer program for use by or in connection with a computer related system or method.

The application 760 can be embodied in any computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable storage medium” can be any means that can store the program for use by or in connection with the instruction execution system, apparatus, or device. The computer readable storage medium can be, for example but not limited to, an electronic, magnetic, optical, electromagnetic, or semiconductor system, apparatus, or a device.

More specific examples (a nonexhaustive list) of the computer-readable storage medium may include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable storage medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In exemplary embodiments, where the application 760 is implemented in hardware, the application 760 can be implemented with any one or a combination of the following technologies, which are well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Technical effects and benefits include configuring a cache memory to a mode that is appropriate to the application for which the cache memory will be used.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A nonexhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer implemented method for providing a configurable cache memory, the method comprising:
configuring, via a cache configuration logic, a plurality of cache memories that make up the configurable cache memory into a selected mode, wherein the plurality of cache memories comprise physically separate memory modules, and wherein the plurality of cache memories are linked by the cache configuration logic; and
operating the configurable cache memory in the selected mode, wherein the configurable cache memory is capable of operating in a plurality of modes, the plurality of modes comprises operating the plurality of cache memories of the configurable cache memory as separate cache memories, wherein each of the plurality of cache memories is assigned to a respective single thread during operation of the configurable cache memory, wherein the plurality of cache memories are kept coherent with one another via a coherency notification interface that notifies each of the plurality of cache memories regarding the fetches and stores that were performed in the other plurality of cache memories.

2. (canceled)

3. The method of claim 1, wherein the selected mode comprises operating the plurality of cache memories as a single cache.

4. The method of claim 3, wherein the selected mode comprises operating the single cache in an extended mode.

5. The method of claim 3, wherein the selected mode comprises operating the single cache in a double line size mode.

6. The method of claim 1, wherein the selected mode comprises operating the plurality of cache memories in a hierarchical mode.

7. The method of claim 6, wherein a first cache memory of the plurality of cache memories comprises a primary cache comprising static random access memory (SRAM), and a second cache memory of the plurality of cache memories comprises a victim cache comprising dynamic random access memory (DRAM).
